(19) United States
(12) Patent Application Publication
(10) Pub. No.: US 2007/0041861 A1
(43) Pub. Date: Feb. 22, 2007

(54) Screw rotor and vacuum pump

(75) Inventors: Osamu Ozawa, Saku City (JP); Takeshi Ichikawa, Saku City (JP); Shinichi Matuda, Saku City (JP)

Correspondence Address: TRASK BRITT, P.O. BOX 2550, SALT LAKE CITY, UT, 84110, US

(73) Assignee: Kashiyama Industries, LTD, Tokyo (JP)

(21) Appl. No.: 11/507,947

(22) Filed: Aug. 22, 2006

(30) Foreign Application Priority Data
Aug. 22, 2005 (JP) JP2005-239691

(51) Int. Cl. F01C 1/16; F04C 2/00; F01C 1/24; F04C 18/00; F03C 2/00

(52) U.S. Cl. 418/201.1; 418/202

(57) ABSTRACT

The invention provides a low-cost screw rotor that is capable of compressing gas. As exemplified in FIG. 4, screw rotors (26, 27) comprise: upstream screw section (43a) defined on the upstream side of the gas travel path with screw thread (41a) identically positioned at the same interval, and downstream screw section (43b) connecting to the downstream side of upstream screw section (43a) along the gas travel path, where threads (41b) on the downstream screw section are arranged continuously with identical pitch smaller than threads (41a) on the upstream screw section; and the upstream end of the downstream screw thread (41b) along the gas travel path and the downstream end of upstream screw thread (41a) along the gas travel path are continuously connected at a yielding point (43c).

### TECHNICAL FIELD

The invention relates to a screw rotor having a threaded outer periphery and a screw-type vacuum pump equipped with a pair of the screw rotors. In particular, the invention relates to a screw rotor that is capable of compressing gas during transportation of gas, and a vacuum pump equipped with the screw rotors.

### BACKGROUND

With respect to a vacuum pump that discharges gas from a vacuum chamber, a screw type vacuum pump that transports and discharges gas by means of rotation of jogged screw rotors having threaded outer periphery is well known. As an example, the herein described screw type dry vacuum pump applying traditional technology (J01) is well-known. (J01) Prior art is described in Patent document 1 (Japanese Patent Laid-open Publication No. 2000-45976)

As described in Patent document 1, a screw-type dry vacuum pump comprises a pair of screw rotors having square thread on the outer periphery with identical lead (distance that a screw thread advances axially in one turn—on a single threaded screw, the lead and pitch are identical). (Japanese Patent Publication No. 2000-45976, paragraph 0022, FIG. 1)

In the case of the screw pump applying traditional technology described in the prior art (J01), the screw rotors are designed to have identical lead (pitch) so that gas is discharged out of a discharge outlet from the upstream side without being compressed.

Regarding compression of gas during gas transportation when screw rotors are used, a continuously variable pitch design of the screw rotor is considered wherein the pitch size at the suction side is maximum, and minimum at the discharge outlet. However, in the case of continuously variable pitch design, a high cost due to complicated machining is regarded as a problem.

In addition, a small clearance is defined between threads of the two intermeshed screw rotors of the screw-type vacuum pump. When the threads have a rectangular tooth shape, they make interference (contact) on the surface of intermeshed threads as they rotate. As a result, the thread profile (interference prevention section) is machined to have a tapering (narrowing) end in order to prevent interference between threads in the case of the conventional screw type vacuum pump. However, since the intermesh interference between the threads becomes large with large lead size, it is required that the profile shape changes continuously with continuously variable pitch. In the case of continuously variable pitch of a thread, failure to carry out thread machining with one end-mill resulting in difficult machining and high cost.

In addition, in order to compress the transported gas when screw rotors are used, in practical applications, the rotor of a large thread lead (large pitch) and the rotor of a small thread lead (pitch) are placed at a certain interval along the same revolving shaft. However, the discontinuous change of discharge volume between the rotor of a large thread lead and the rotor of a small thread lead results in low discharge efficiency. Moreover, because the two rotors are arranged at an interval, axial length of rotor (rotor length) tends to be increased. If the rotor length is increased, the dimension of the whole unit is forced to increase, together with the need for bearings to be mounted to support the revolving shaft at both ends as well as at the vacuum side. If bearings are mounted at the vacuum side, it becomes necessary to provide lubricant for the bearings; furthermore, measures should be taken to prevent pollution to the vacuum chamber resulting in a complicated structure and high cost.

### SUMMARY OF INVENTION

The invention provides a screw rotor at low cost that is capable of compressing air. The invention also increases discharge efficiency of a screw rotor and shortens the rotor length.

In aspect 1 of the invention, a screw rotor is designed to be in possession of the following features. The screw rotor having threaded outer periphery rotates around the revolving shaft to transport gas. The screw rotor comprises two sections: an upstream screw section on the upstream side and a downstream screw section connecting the downstream side of the upstream screw section along the gas travel path.

The threads on the upstream screw section are arranged at an identical pitch and the threads on the downstream screw section are arranged continuously at identical pitch smaller than that on the upstream screw section. The downstream end of the upstream screw threading along the gas travel path and the upstream end of the downstream screw threading along the gas travel path are continuously connected through inflexion points.

The screw rotor further has threads on its outer periphery to rotate around a revolving shaft so as to transport gas. On the upstream side along the gas travel path, upstream threads are formed at identical intervals. On the downstream screw section connected with the downstream end of the upstream screw section along the gas travel path, the threads are formed continuously at identical interval smaller than that on the upstream screw section. Besides, in the downstream screw section, the downstream end of the upstream thread along the gas travel path and the upstream end of the downstream thread along gas travel path are continuously connected through inflexion points.

Accordingly, both the upstream and downstream screw sections of the screw rotor in aspect 1 are formed at identical pitch, resulting in easy manufacture and low cost compared with the case of continuously variable pitch.

Furthermore, because the pitch of the downstream screw section is smaller than that of the upstream section on the screw rotor in aspect 1, gas is compressed as it travels from the upstream section to the downstream section. In the meantime, the downstream end of the upstream screw section and the upstream end of the downstream screw section are continuously connected at a yielding point, therefore, the gas discharge volume changes continuously near the yielding point. Compared to the screw rotor of variable pitch design whose gas discharge volume is not continuous, the screw rotor of the invention increases discharge efficiency and shortens the rotor length. In addition, the design of a shortened rotor length makes it easy to apply a stay bracket of bearings on one end of the revolving shaft.

In Form 1 of aspect 1, the screw rotor possesses the following features: it comprises an upstream interference prevention section on the upstream screw section and a downstream interference prevention section on the downstream screw section. The upstream interference prevention section on the upstream screw section is designed with tapering end of tread on upstream thread profile, and thread shape of the downstream interference prevention section on downstream thread profile of the downstream screw section is different from that of upstream interference prevention section.

With respect to the screw rotor described in form 1 of aspect 1, an upstream interference prevention section is designed on the thread profile of the upstream screw section with tapering end of thread, and similarly, a downstream interference prevention section is formed on the downstream thread profile of the downstream screw section that has thread shape different from that of upstream interference prevention section. Therefore, interference prevention areas are formed in order to prevent interference between intermeshed screw rotors.

In aspect 2 of the invention, a vacuum pump is characterized by including the screw rotor in aspect 1 or form 1 of aspect 1. Since the vacuum pump comprising the components in aspect 2 has the same screw rotors as that in aspect 1 or form 1 of aspect 1, it has the same effect as aspect 1 or form 1 of aspect 1.

The foregoing described invention makes it possible to provide a screw rotor that is capable of compressing gas at low cost. Moreover, it is capable of increasing the discharge efficiency as well as shortening the rotor length.

### DESCRIPTION OF THE FIGURES

FIG. 1 is an overall illustration of screw type dry vacuum pump.

FIG. 2 is an illustration of the screw rotor in embodiment 1. FIG. 2A is the sectional view, and FIG. 2B the side view, FIG. 2C illustrates the view taken from the direction of arrow IIC in FIG. 2B, FIG. 2D illustrates the view taken from the direction of arrow IED in FIG. 2B.

FIG. 3 illustrates the main part of the screw rotor. FIG. 3A is a sectional view along line IIIA-IIIA of FIG. 2B, FIG. 3B shows an enlarged illustration of IIIA section in FIG. 2A, and FIG. 3C shows an enlarged illustration of IIIC section in FIG. 2A.

FIG. 4 is the expanded view of the screw rotor profile in embodiment 1.

FIG. 5 is an overall illustration of a screw type vacuum pump in embodiment 2, corresponding to FIG. 1 of embodiment 1.

FIG. 6 illustrates a screw rotor in embodiment 2 corresponding to FIG. 2 in embodiment 1. FIG. 6A is a sectional view, FIG. 6B is a side view, FIG. 6C is a sectional view taken from arrow VIC of FIG. 6B, FIG. 6D is a sectional view taken from arrow VID of FIG. 6B. FIG. 6E shows an enlarged illustration of VIE section in FIG. 6A.

FIG. 7 is an expanded view of the screw rotor profile in embodiment 2, corresponding to FIG. 4 in embodiment 1.

### DETAILED DESCRIPTION OF THE INVENTION

Various embodiments of application of the invention are illustrated in the accompanying drawings. It should be understood that applications of the invention are not limited to the following embodiments.

Symbols used throughout in the Specification and the FIGS are explained as follows:

1. . . vacuum pump,

21, 22. . . revolving shafts,

26, 27, 26′, 27′. . . screw rotor

41a . . . upstream thread

41b . . . downstream thread

43 . . . screw

43a, 43a′ . . . upstream screw section

43b, 43b′ . . . downstream screw section

43c . . . yielding point

44a . . . upstream interference prevention section

44b . . . downstream interference prevention section

In order to make the illustration easily understood, the following definition is made to specify directions. X axis: the longitudinal (forward and aft), Y axis: the lateral (inward and outward) and Z axis: the vertical (up and down); and arrow marks X, -X, Y, -Y, Z,and -Z stand, respectively, for forward, aft, right, left, up and down in the drawings. In addition, the symbol ┌□┘ in ┌∘┘ represents an arrow directing out of the paper, and ┌x ┘ in ┌∘┘ represents an arrow directing into the paper.

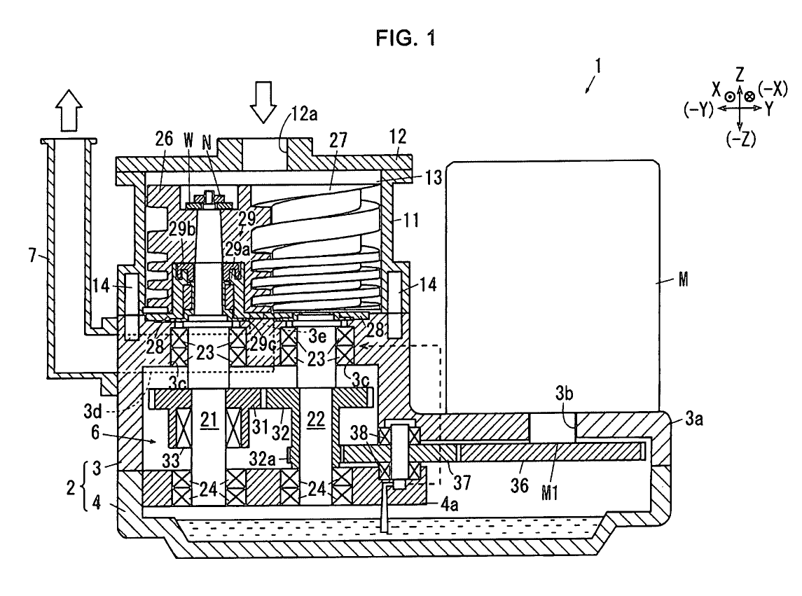

Embodiment 1 of the invention is further explained as follows. FIG. 1 is an overall illustration of a screw type dry vacuum pump. It shows in FIG. 1 that there is a base 2 mounted in the screw type dry vacuum pump 1 in the invention. The upper base 3 and lower base 4 are mounted on base 2, with a gear room 6 designed within base 3 and base 4. On the right side of base 2, motor stand 3a to support pump motor M is mounted. A motor shaft through-hole 3b is drilled on motor stand 3a for motor shaft M1 to go through. On the left side of the upper end of upper base 3, a pair of upper bearing saddles 3c is mounted. On the left side of upper base 3, discharge duct 7 is fixed, with which the downstream end of discharge passage 3d formed within base 3 is connected. Discharge outlet 3e is formed on the upstream end of discharge passage 3d. On the upper end of the left side of lower base 4, lower bearing saddle 4a is mounted. Lubricant for bearing lubrication is stored at the bottom of lower base 4.

To the left of the upper end of upper base 3, a cylinder casing 11 is mounted. The top of casing 11 is blocked by cover 12. On cover 12, a suction inlet 12a while not shown in the drawings is connected with the vacuum chamber. Therefore, pump chamber 13 is defined in the internal space generated by the upper surface of upper base 3, casing 11 and cover 12, where suction inlet 12a is formed on the top and exhaust outlet 3e at the bottom. At the bottom of said casing 11 as well as around the outer periphery of upper base 13, a doughnut-shaped cooling circuit 14 is mounted in which cooling water runs for cooling pump chamber 13.

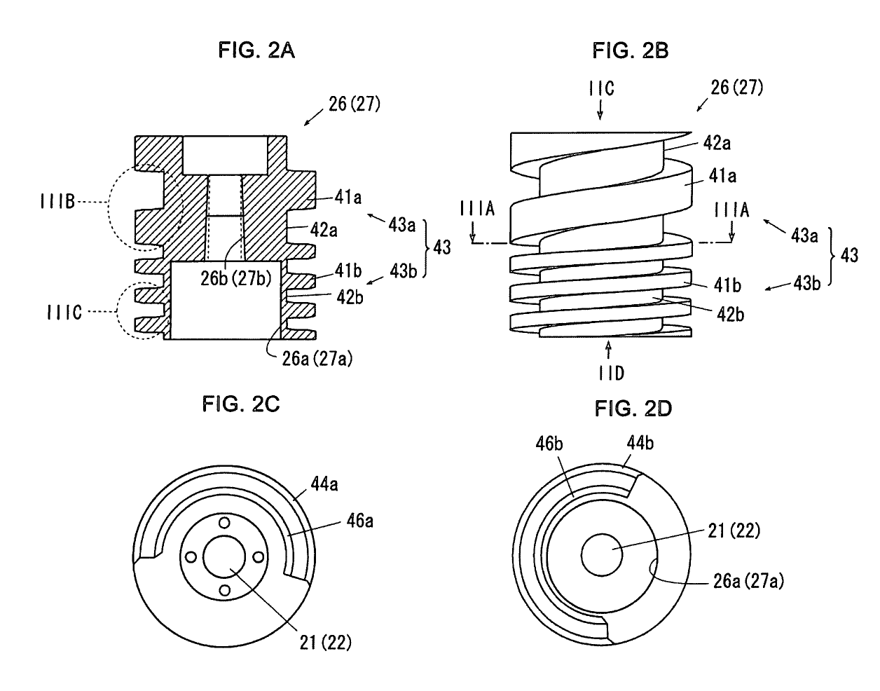

Within base 2 as well as casing 11, a pair of rotor axles (revolving shaft) 21, 22 are mounted at both left and right sides going through pump chamber 13 and gear room 6. Rotor axles 21 and 22 are supported by upper bearing saddles 3c and lower bearing saddle 4a in gear room to rotate by means of bearings 23 and 24. Within pump chamber 13 where rotor axles 21 and 22 are mounted, the intermeshed left and right screw rotors 26 and 27 are fixed. Within the bottom of screw rotors 26 and 27, seal recesses 26a and 27a (referring to FIG. 2) are designed. On the top of seal recesses 26a and 27a, tapering axial through-holes 26b and 27b are made, and the tapering top of rotor axles 21 and 22 go through axial through-holes 26b and 27b. At the top end of rotor axles 21 and 22, screw threads are drilled and screwed tightly with nut N through washer W; therefore, rotor axles 21 and 22 are fixed together with screw rotors 26 and 27 thereby rotating integrally.

Housing 28 for seal installation is fixed on the top of the upper bearing 23. In seal recess 26a, oil seal 29a fixed on seal installation housing 28, together with the two flingers 29b and 29c that rotate with rotor axles 21 and 22, comprises the seal system 29 functioning on prevention of leakage and reverse flow of gas and lubricant, etc.

In gear room 6, timing gears 31 and 32 are fixed to rotor axles 21 and 22 in an intermeshed state to transmit the driving power. In addition, in the vacuum pump described in embodiment 1, a rotation transmission gear 32a is fixed at the bottom of right timing gear 32, and the right timing gear 32 is fixed rotationally with right rotor axle 22 integrally through the key and key groove that are not shown in the drawings. Furthermore, left timing gear 31 is connected with left rotor axle 21 through joint 33. By means of joint 33, the intermesh of gears 31 and 32 as well as that of screw rotors 26 and 27 is easily obtained.

Drive gear 36 is fixed on the driving shaft M1 of pump motor M. Rotation is transmitted to timing gears 31 and 32 through drive gear 36 together with the mid-gear 37 that is intermeshed with rotation transmission gear 32a. In addition, bearing 38 that rotationally supports mid-gear 37, together with other bearings 23 and 24, are lubricated by the lubricant stored in lower base 4 through a lubricant supply device that is not shown in drawings.

FIG. 2 is an illustration of the screw rotor in embodiment 1. FIG. 2A is the sectional view. FIG. 2B is a side view. FIG. 2C illustrates the view taken from the direction of arrow IIC in FIG. 2B. FIG. 2D illustrates the view taken from the direction of arrow IID in FIG. 2B.

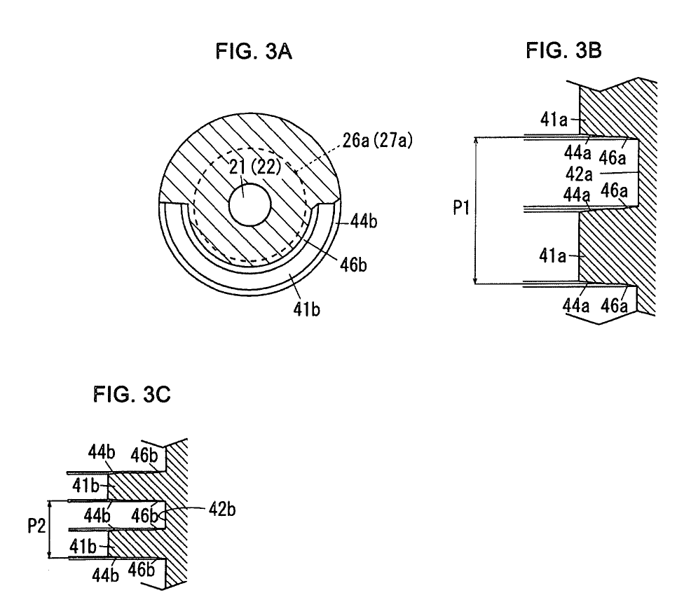

FIG. 3 illustrates the main part of the screw rotor. FIG. 3A is a sectional view taken along line IIIA-IIIA of FIG. 2B. FIG. 3B shows an enlarged illustration of IIIA section in FIG. 2A. FIG. 3C shows an enlarged illustration of IIIC section in FIG. 2A.

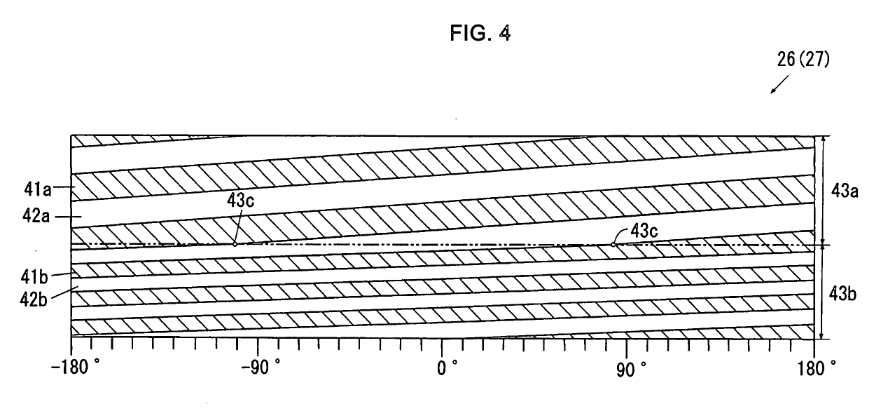

FIG. 4 is the expanded view of the screw rotor profile in embodiment 1. As show from FIG. 2 to FIG. 4, one screw 43 with screw thread 41 and valley 42 is formed on the outer periphery of screw rotors 26 and 27 in embodiment 1. Screw 43 comprises upper upstream screw section 43a on the upstream side of the gas travel path and lower downstream strew section 43b on the downstream side of the gas travel path.

In FIG. 3B and FIG. 4, adjacent upstream threads 41a are designed with identical distance (pitch p1, referring to FIG. 3B), with equal width of upstream screw valley 42a on upstream screw 43a. In FIG. 3C and FIG. 4, adjacent downstream threads 42a are designed with identical distance (pitch p2, referring to FIG. 3C), with equal width of upstream screw valley 42b on downstream screw 43b. Moreover, pitch p2 (referring to FIG. 3C) is designed to be narrower in width compared with that of upstream screw 43a.

The downstream end of upstream screw section 43a and the upstream end of the downstream screw section 43b are continuously connected at yielding points 43c and 43c in FIG. 4. Accordingly, near the yielding points 43c and 43c, the gas discharge volume changes smoothly in a continuous way, thus gas discharge volume changes continuously from upstream screw section 43a to the downstream screw section 43b.

In FIG. 2C, FIG. 2D, FIG. 3B and FIG. 3C, on the end of thread profile of screw threads 41a and 42a, interference prevention sections 44a and 44b are designed through cutting (chamfering machining) in order to remove interference when rotors 26 and 27 have rectangular teeth (which did not undergo chamfering). Moreover, with respect to interference prevention sections 44a and 44b, since the shape of upstream interference prevention section 44a is different from that of the downstream interference prevention section 44b, interference on the upstream side with a large lead tends to be large. Correspondingly, more cutting is required on the upstream interference prevention section 44a than on the downstream interference prevention section 44b.

In addition, on the surface near the root of screw threads 41a and 42a, gap filling sections 46a and 46b are generated to fill the space between interference prevention sections 44a and 44b and the thread surface of screw threads 41a and 42a corresponding to the cutting of interference prevention sections 44a and 44b. The existence of space between interference prevention sections 44a and 44b and the thread surface of screw threads 41a and 42a while rotors 26 and 27 are in intermeshed state will cause gas leaks and reverse flow; accordingly, discharge efficiency will decrease. Therefore, in embodiment 1, by means of clearance filling section 46a and 46b, intermeshing is realized when rotors 26 and 27 are in intermeshed state; when the intermesh is released, interference generated is removed by interference prevention sections 44a and 44b.

In vacuum pump 1 having the structure described in embodiment 1, rotation is transmitted by gears 31, 32, 36 and 37 when pump motor M1 starts; then rotor axles 21 and 22 start to rotate; furthermore, screw rotors 26 and 27 start to rotate. Accompanying the rotation of the screw rotors 26 and 27, gas is transported by means of screw 43. The gas inhaled from suction inlet 12a is discharged from discharge outlet 13.

On the screw rotors 26 and 27 defined in embodiment 1, upstream screw section 43a of a large lead (large pitch) on the upstream side is designed while downstream screw section 43b of a small lead (small pitch) on the downstream side is designed. Therefore, gas passing through upstream screw section 43a is compressed by means of a smaller gas discharge volume upon the arrival at downstream screw section 43b. Besides, the fact that upstream screw section 43a and downstream screw section 43b are connected continuously at yielding point 43c leads to a continuously changeable gas discharge volume, in addition to the fact that the upstream screw section and downstream screw section are arranged with no space in between; therefore, gas discharge efficiency is superior compared with the case when the gas discharge volume changes in discontinuity.

Furthermore, since the upstream screw section and downstream screw section are arranged with no space in between, rotor length can be shortened. Accordingly, the design of a stay bracket without the arrangement of a bearing on the vacuum side (on the side of suction inlet 12a) is applicable, as shown in FIG. 1.

Moreover, corresponding to the degree of interference, interference prevention sections 44a and 44b are arranged on screw rotors 26 and 27 to remove interference when rotors are released from intermesh. In addition, the advantage that space is filled by means of gap filling sections 46a and 46b leads to reduction of gas leakage and increase of discharge efficiency.

In addition, for screw rotors 26 and 27 defined in embodiment 1, it is possible to make screw rotors 26 and 27 as follows: the screw thread higher than the yielding point 43c is machined by a large lead cutting tool, and the screw thread lower than the yielding point 43c is machined by a small lead cutting tool. Therefore, compared with the case that the pitch of the screw thread is continuously variable, machining of screw rotors 26 and 27 is easier. In addition, compared with the case of continuously variable shape, it is easy to make interference prevention sections 44a and 44b since they have two different shapes, resulting in low cost.

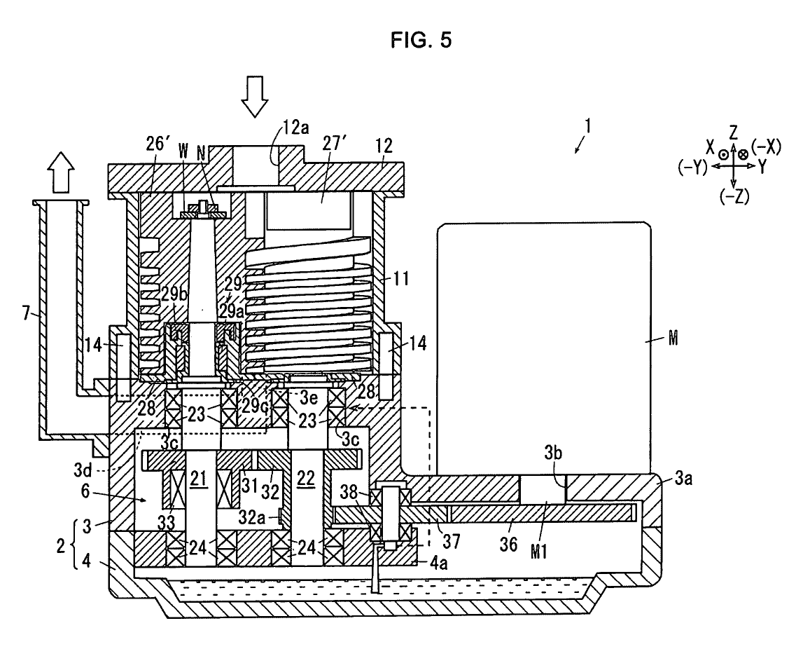

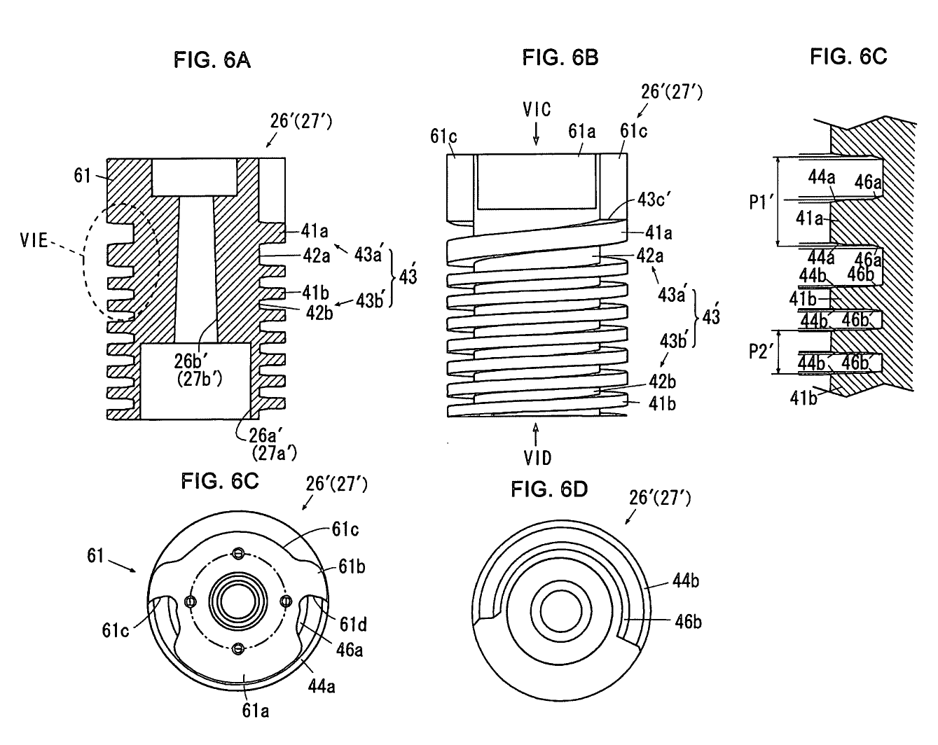

Embodiment 2 of the invention is further explained as follows. FIG. 5 is an overall illustration of screw type vacuum pump in embodiment 2, corresponding to FIG. 1 embodiment 1. FIG. 6 illustrates screw rotor in embodiment 2 corresponding to FIG. 2 of embodiment 1. FIG. 6A is a sectional view. FIG. 6B is a side view. FIG. 6C is a sectional view taken from arrow VIC FIG. 6B. FIG. 6D is a sectional view taken from arrow VID of FIG. 6B. FIG. 6E shows an enlarged illustration of VIE section in FIG. 6A.

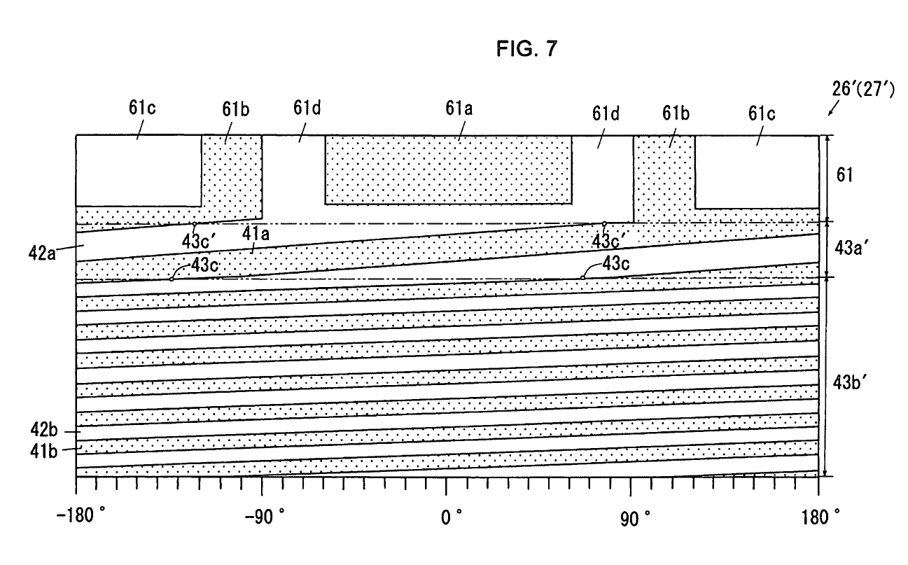

FIG. 7 is the expanded view of the screw rotor profile in embodiment 2, corresponding to FIG. 4 in embodiment 1. Additionally, regarding the illustration of embodiment 2, same symbols for the corresponding components are used as in embodiment 1 whith specific explanation of the symbols omitted. Regarding the components of embodiment 2, it is the same as those of embodiment 1 except the following features.

As shown in FIG. 5 to FIG. 7, screw type vacuum pump 1 of embodiment 2 is equipped with screw rotors 26′ and 27′ which are different from the screw rotors 26 and 27 of the embodiment 1. In screw rotors 26′ and 27′ of the embodiment 2, an innite lead section 61 is formed continuously, on the upstream side of gas travel path, further up than upstream screw section 43a (the side of suction inlet 12a), with a length corresponding to thread lead infinitely great. Infinite lead section 61 comprises small circle section 61a and large circle section 61b. On large circle section 61b, a circular excision 61c is formed. In addition, gas compression section 61d is formed between small circle section 61a and large circle section 61b. As described in patent document 1 (referring to rotor extensions 7 and 8 in patent document 1), being normally well-known, infinite lead section 61 is applied to discharge gas by a discharge mechanism depicted in FIG. 3 of Patent document 1, therefore, detailed illustration is omitted. Additionally, in the structure described in patent document 1, the center of gravity of infinite rotor section 61 deviates. It becomes ill-balanced as screw rotors 26′ and 27′ rotate. In embodiment 2 of the invention, excision 61c is applied on infinite rotor section 61 to keep screw rotors 26′ and 27′ in a balanced state.

In FIG. 6 and FIG. 7, the downstream end of upstream screw section 43a′ is continuously connected with the upstream end of downstream screw section 43b′ at yielding points 43c and 43c; in addition, the upstream end of upstream screw 43a′ is continuously connected with the downstream end (lower end) of infinite lead section 61 at yielding point 43c′ and 43c′ in screw rotors 26′ and 27′.

Furthermore, in screw rotors 26′ and 27′of the embodiment 2, more thread turns of downstream screw section 43b′ (7 turns) are designed compared with that in the case of embodiment 1.

In the screw type vacuum pump 1 that has the structure defined in embodiment 2, gas is compressed as it travels from infinite lead section 61 to upstream screw section 43a′ as well as from upstream screw section 43a′ to downstream screw section 43a′. Therefore, compression ratio is increased.

In addition, in screw rotors 26′ and 27′of the embodiment 2, the fact that infinite lead section 61 is continuously connected with upstream end of upstream screw section 43a′ at yielding point 43c′ with no space in between, together with the fact that the upstream screw section 43a′ and downstream screw section 43b′ are continuously connected at yielding point 43c, make it possible for the rotor length of screw rotors 26 and 27 to be shortened. Consequently, application of stay bracket is easy to accomplish. Furthermore, continuous connection enables continuously changeable discharge volume resulting in increased discharge efficiency.

Furthermore, with respect to screw rotors 26′ and 27′of the embodiment 2, more thread turns of downstream screw section 43b′ of small lead are designed so that transported gas is separated into more parts. Accordingly, it can reduce leakage from discharge outlet 3e to suction inlet.

Apart from the foregoing description, vacuum pump 1 of embodiment 2 has similar effect to that of embodiment 1. Some embodiments of the invention have been the described in detail, but it is to be understood that the invention is not limited exclusively to the described embodiments, within the scope of the claims of the invention, variations can be made Variations (H01) to (H06) of the invention are illustrated below.

(H01) In the embodiments, it is possible to install additional one or more screw threads on the upstream side of upstream screw sections 43a and 43a′ or the downstream side of downstream screw sections 43b and 43b′. That is, it is possible to design a screw rotor with more than three screw sections instead of 2.

(H02) In the embodiments, it is preferred that screw 43 comprises one thread; however, screw 43 may comprise more than two threads.

(H03) In various embodiments, the specific numbers of thread turns of screws and the length of lead, p1, p2, p1′ and p2′, as well as the rotor length, can be varied based on specific designs.

(H04) In the embodiments, it is possible to install roots rotor instead of infinite lead 61 as described in patent document 1.

(H05) In the embodiments, the threads are designed to be curved and continuously connected at yielding point 43c and 43c′. In addition, it should be understood that it is also possible to cut off the curved angle so as to connect smoothly near the yielding point.

(H06) In the embodiments, the driving force of pump motor M that is supported by motor stand 3a is transmitted to rotor axles 21 and 22 through gear 36 and mid-gear 37; however, it is not limited to the present structure. Either of rotor axles 21 and 22 can support the motor rotor with a motor starter located around the rotor; that is to say, a built-in motor structure can be applied. Incorporation of the built-in motor results in a compact structure and reduced cost.

What is claimed is:

1. A screw rotor having a threaded outer periphery for transporting gas while rotating around a revolving shaft, comprising
an upstream screw section on an upstream side and a downstream screw section that is connected to the downstream side of said upstream screw section along the gas travel path,
wherein the threads on the upstream screw section are arranged at a first identical pitch and the threads on the downstream screw section are arranged continuously at a second identical pitch that is smaller than that on said upstream screw section, and
wherein the downstream end of said upstream screw threading along the gas travel path and the upstream end of said downstream screw threading along gas travel path are continuously connected at a yielding point.

2. The screw rotor of claim 1, wherein an upstream interference prevention section comprising a tapering end on the upstream thread profile is formed on said upstream screw section; a downstream interference prevention section is formed on said downstream screw section; and the shape of the upstream interference prevention section is different from that of the downstream interference prevention section.

3. A vacuum pump comprising the screw rotor of claim 1.

4. A vacuum pump comprising the screw rotor of claim 2.
